(19) United States
(12) Patent Application Publication
(10) Pub. No.: US 2010/0228725 A1
(43) Pub. Date: Sep. 9, 2010

(54) PLANT INFORMATION MANAGING DEVICE AND PLANT INFORMATION MANAGING METHOD

(75) Inventors: Masayasu Ohashi, Tokyo (JP); Susumu Okuno, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/716,416

(22) Filed: Mar. 3, 2010

(30) Foreign Application Priority Data
Mar. 9, 2009 (JP) 2009-054966

(51) Int. Cl. G06F 17/30; G06F 3/048

(52) U.S. Cl. 707/722; 715/772; 707/E17.014

(57) ABSTRACT

Terminal device 5 includes a designation receiving section 51 for receiving a designation of time series data, a searching section 52 for searching the time series data according to searching conditions for the designation of the time series data which has been received by the designation receiving section 51, a statistical processing section 53 for performing a statistical processing based on the time series data which has been extracted from the search by the searching section 52, and a display section 54. The display section 54 graphically displays the time series data, which has received the designation by the designation receiving section 51 and at the same time displays the results of the statistical processing by the statistical processing section 53.

### CROSS-REFERENCE TO RELATED APPLICATION

This application is based on and claims priority under 35 U.S.C. §119 from Japanese Patent Application No. 2009-054966 filed on Mar. 9, 2009.

### BACKGROUND OF THE INVENTION

1. Technical Field

The present invention relates to a plant information managing device and a plant information managing method for managing a data group relating to a plant.

2. Related Art

It is very important to operate a plant securely, discover abnormalities early and respond thereto. For this reason, early and accurate responding to process and device abnormalities is one of the important tasks for an operator of a plant. At the time of occurrence of an abnormality, an operator performs a series of works that recognizes the occurrence of the abnormality by a notification of an alarm and an alarm message, understands the situation to deduce the cause thereof, and selects a response method.
[Patent Document 1] JP-A-2009-009399

However, when a cause is deduced and a response method is selected, they are greatly based on past experience and intuition, and as a consequence, products quality is not stabilized due to the difference between the operators. Furthermore, since a judgment standard or a judgment method of the operator at the time of selecting the response method is not effectively used as shared information, the experience of an individual operator is not shared with other operators and it is difficult to improve skill.

### SUMMARY OF THE INVENTION

An object of the present invention is to provide a plant information managing device and a plant information managing method that can effectively use a data group relating to a plant.

According to a first aspect of the invention, there is provided a plant information managing device for managing a time series data group relating to a plant, including:

a designation receiving section for receiving a designation of the time series data, and

a display section for graphically displaying the time series data which has received the designation by the designation receiving section.

According to the plant information managing device, the time series data, which has received the designation, is graphically displayed so that a data group relating to the plant can be effectively used.

According to a second aspect of the invention, there is provided the plant information managing device as in the first aspect, further including:

a searching section for searching the time series data according to a searching condition for designating the time series data which has been received by the designation receiving section, wherein

the display section graphically displays the time series data which has been extracted from the search by the searching section.

According to a third aspect of the invention, there is provided the plant information managing device as in the first or second aspect, wherein

the display section displays the graphical displays of a plurality of the time series data in such a manner that time axes thereof are uniformly arranged in relation to each other.

According to a fourth aspect of the invention, there is provided the plant information managing device as in any one of the first to third aspects, further including:

a statistical processing section for performing a statistical processing based on the time series data which has been extracted from the search by the searching section, wherein

the display section displays the results which are based on the statistical processing according to the statistical processing.

According to a fifth aspect of the invention, there is provided the plant information managing device as in any one of the first to fourth aspects, wherein

the time series data relates to alarm information.

According to a sixth aspect of the invention, there is provided the plant information managing device as in any one of the first to fifth aspects, wherein

the time series data relates to an operation in a plant.

According to a seventh aspect of the invention, there is provided the plant information managing device as in any one of the first to sixth aspects, wherein

the time series data is historical data.

According to an eighth aspect of the invention, there is provided a plant information managing method of managing a time series data group relating to a plant, including:

receiving a designation of the time series data, and

graphically displaying the time series data which has been received in the step of receiving the designation.

According to the plant information managing method, the time series data which has received the designation is graphically displayed, so that the data group relating to the plant can be effectively used.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are diagrams showing a structure of a field control system to which a plant information managing device is applicable, FIG. 1A is a block diagram showing the structure of the field control system, and FIG. 1B is a block diagram showing a structure of a terminal device;

FIG. 2 is a diagram showing an example of “a product unit” as an imaginary unit;

FIG. 3 is a diagram showing an example of “a process unit” as an imaginary unit;

FIG. 4 is a diagram showing examples of “a raw material unit”, “a utility unit”, and “a person unit” as imaginary units;

FIG. 5 is a diagram showing an example of “a device unit” of an imaginary unit;

FIGS. 6A and 6B are diagrams showing an example of corresponding relationship between each time series data stored in an imaginary unit and a display configuration of each data, FIG. 6A is a diagram showing a corresponding relationship in a unit which stores the time series data group relating to a product, and FIG. 6B is a diagram showing a corresponding relationship in a unit which stores a time series data group relating to a utility;

FIG. 7 is a diagram that shows an example of a corresponding relationship between each time series data stored in an imaginary unit and a display configuration of each data, and shows a corresponding relationship in a unit that stores a time series data group relating to a raw material to be input;

FIGS. 8A and 8B are diagrams showing an example of a corresponding relationship between each time series data stored in an imaginary unit and a display configuration of each data, FIG. 8A is a diagram showing a corresponding relationship in a unit that stores the time series data group relating to a person, and FIG. 8B is a diagram showing a corresponding relationship in a unit that stores the time series data group relating to a device (reactor).

FIG. 9 is a diagram showing an interpretation screen when a trouble arises in a product.

FIG. 10 is a diagram showing an interpretation screen of a batch process.

FIG. 11 is a diagram showing a display screen which shows detailed information of a device.

FIG. 12 is a diagram showing a display screen of report information of a trouble.

FIGS. 13A and 13B are diagrams showing a writing method of a past case, FIG. 13A is a diagram showing an example of an event (time series data) constituting the past case of a response to an alarm, and FIG. 13B is a diagram showing an example of field data (time series data) contained in a device unit (resistor unit);

FIG. 14 is a diagram showing a graphical display example of the written past case;

FIGS. 15A and 15B are diagrams showing a display screen, FIG. 15A is a diagram that shows an example in which timings of events in a plurality of the past cases are graphically displayed, and FIG. 15B is a diagram that shows a display screen example which displays the number distributions of operation contents subsequently adopted; and

FIG. 16 is a diagram showing an example in which a careful selection condition is divided into two step layers.

### DETAILED DESCRIPTION OF THE PREFERRED EMBODIMENTS

Hereinafter, an embodiment of a plant information managing device of the present invention is described.

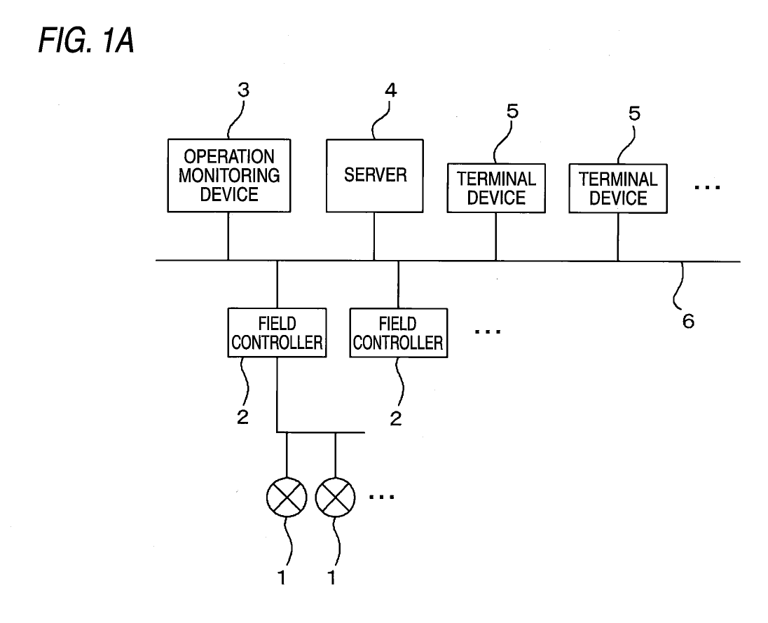

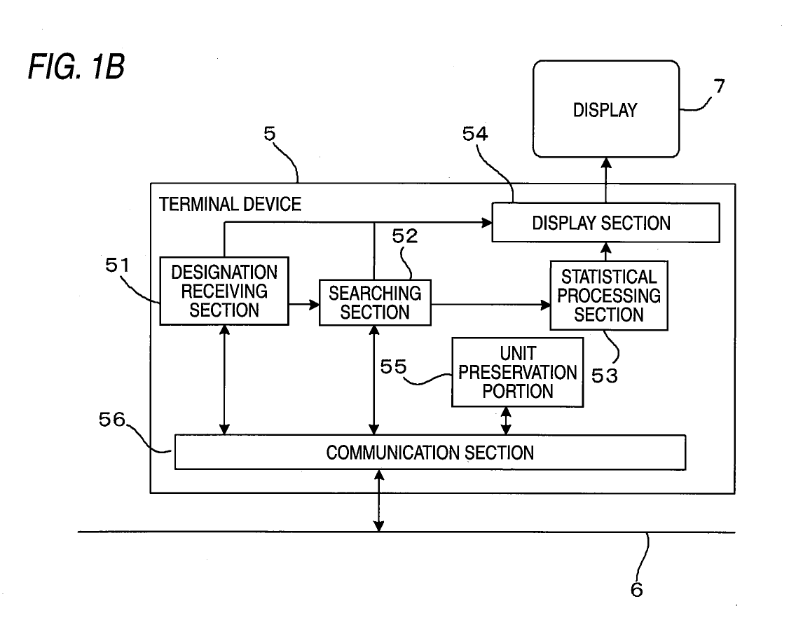

FIGS. 1A and 1B are block diagrams that show structures of field control systems to which a plant information managing device of the present invention is applicable.

As shown in FIG. 1A, the field control system includes field controllers 2, which are divided into the plant, an operation monitoring device 3 for operational monitoring of the field equipments 1 via the field controllers 2, a sever 4 for storing data such as field data and other data relating to the plant, and terminal devices 5 for performing accesses to various data relating to the plant. The field controllers 2, the operation monitoring device 3, the server 4 and the terminal devices 5 are connected to each other via a network 6.

The data stored in the server 4 includes an event, an alarm, and historical data relating to an operation. The historical data is a time series data and a time stamp is attached to the historical data.

As shown in FIG. 1B, the terminal devices 5 include a designation receiving section 51 for receiving a designation of time series data, a searching section 52 for searching the time series data according to searching conditions for the designation of the time series data which has been received by the designation receiving section 51, a statistical processing section 53 for performing a statistical processing based on the time series data which has been extracted from the search by the searching section 52, and a display section 54 for graphically displaying the time series data, which has received the designation by the designation receiving section 51 and at the same time displaying results of the statistical processing by the statistical processing section 53.

Furthermore, in the terminal device 5, there are installed a unit preservation portion 55 for preserving an imaginary unit, and a communication portion 56 for communicating via the network 6.

In the plant information managing device of the present embodiment, information management using an imaginary unit is executed. Basic structures of the imaginary unit include “a name”, “a data main body”, and “a property (attribute)”. In the “data main body”, current data/historical data, current message/historical message, a method, and a file and the like are included.

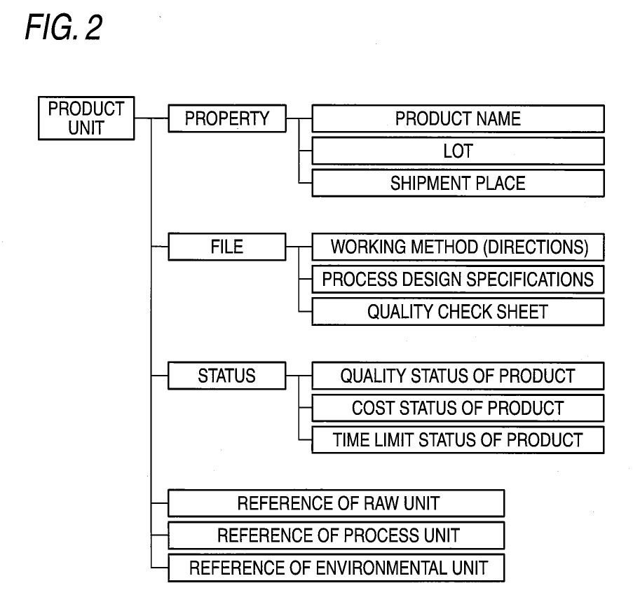

FIGS. 2 to 6 are diagrams that exemplify the structure of the imaginary unit. The imaginary unit is a bundle of data relating to a plant, and the contents of the imaginary unit can be freely set via the terminal device 5 by a user. The data stored in the imaginary unit can designate any data irrespective of whether such is logical data/physical data. The written imaginary unit is preserved in the unit preservation portion 55.

In addition, in the “data” stored in the imaginary unit, information specifying the data or a meaning (for example, “a value of present field data”) of the data is included, and “a data value” or “an image” does not need to be stored. The field data and the historical data, and other data values and images can be properly obtained via the network 6.

FIG. 2 shows an example of “a product unit” as an imaginary unit. The product unit monitors the product produced in the plant, and is a collection of information that collates the data related to each step from the raw materials to the products. In the example shown in FIG. 2, the data relating to the products are classified and stored into “a property” showing an attribute of a product, “a file” showing an image file relating to a product, and “status” showing a state relating to a product. In addition, as a unit that is referable by a development from a display screen, a raw material unit, a process unit and an environment unit are designated.

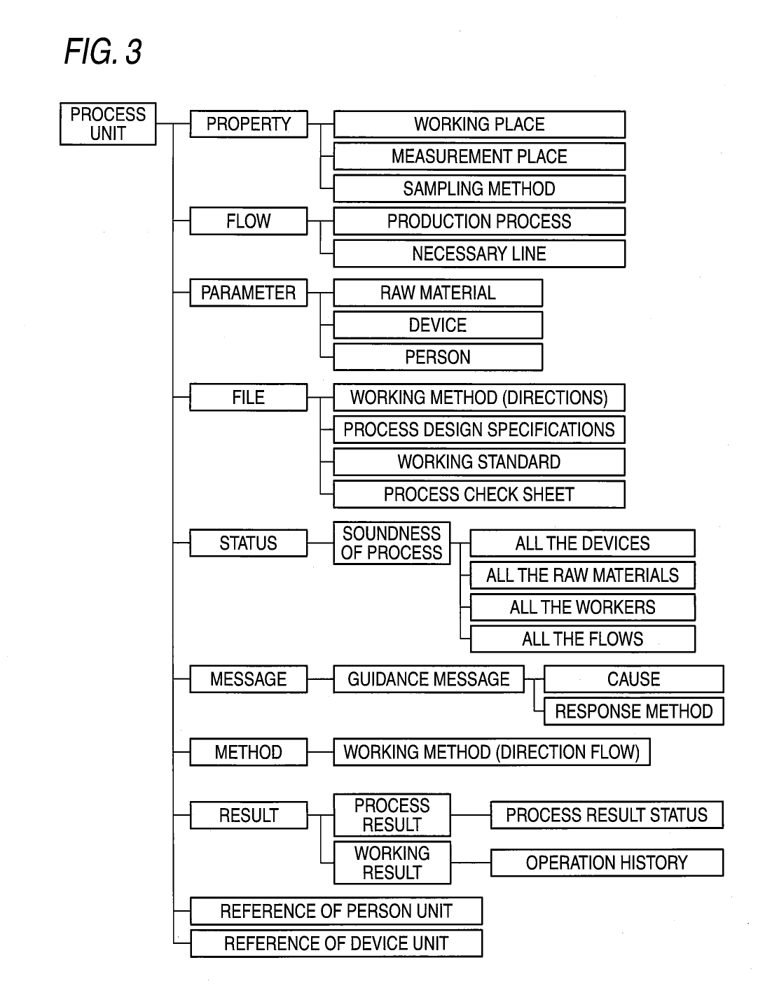

FIG. 3 shows an example of “a process unit” as an imaginary unit. The process unit monitors processes of producing a product, and is a collection of information that collates the relationship of each processes and a related data. In the example shown in FIG. 3, data relating to processes are classified and stored into “properties” showing attributes of processes, and “flow” showing the data relating to the flow of the production or the like. Furthermore, as units that are referable by development from a display screen, a person unit and a device unit are designated.

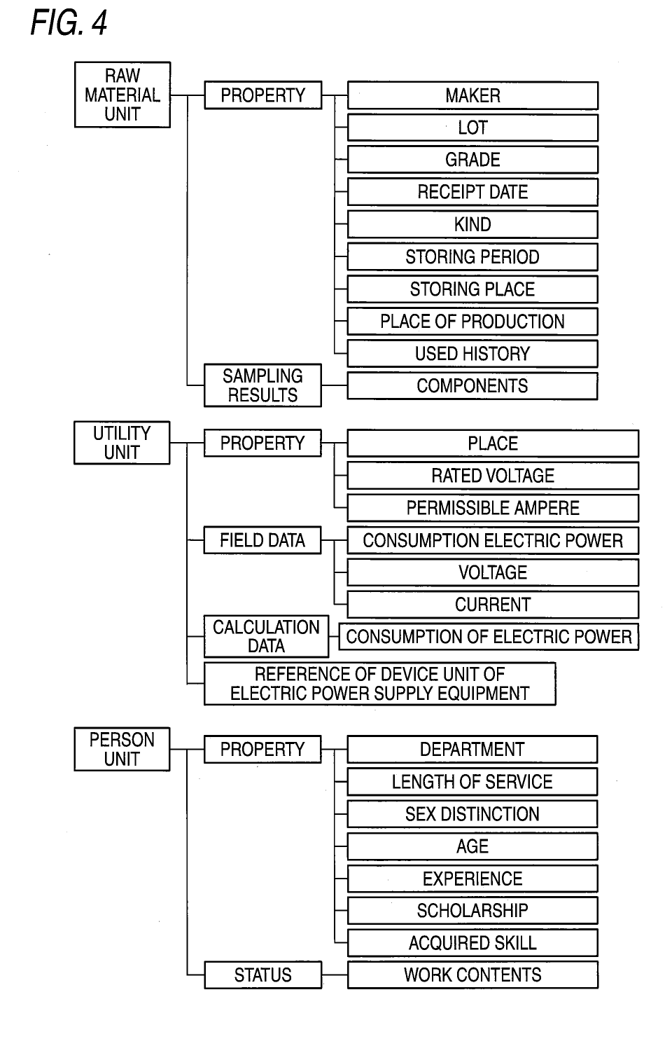

“A raw material unit” shown in FIG. 4 is an imaginary unit that monitors raw materials for making products and collates data relating to raw materials.

“A utility unit” shown in FIG. 4 is an imaginary unit that monitors utilities required for production in plants and collates data such as amounts used at every building.

“A person unit” shown in FIG. 4 is an imaginary unit that monitors a person engaged in the plant and collates data relating to the person.

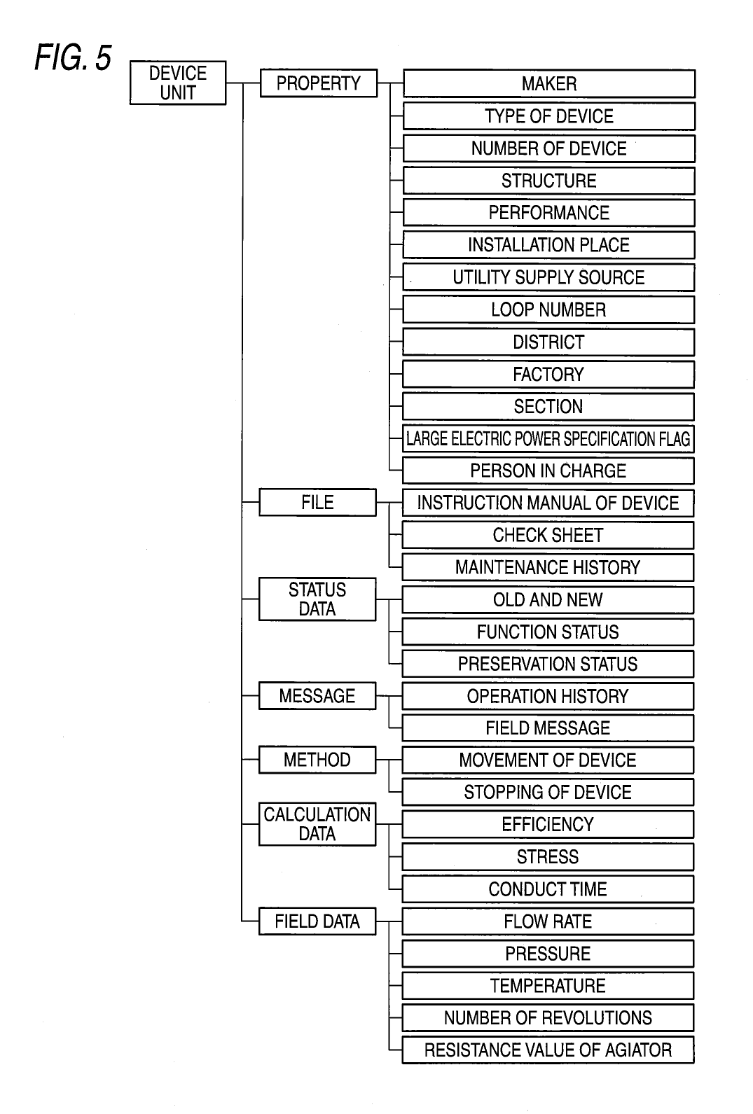

“A device unit” shown in FIG. 5 is an imaginary unit that monitors a device of a plant and collates data relating to the device.

In addition, it is possible to write “a task unit” which monitors works of a person engaged in a plant and collates data relating to work content, “a task unit” which monitors a natural environment around a plant and collates data such as weather and season, “a trouble unit” which monitors claims from clients after products are released and collates data such as causes and responses on an individual claim basis, and an “a interpretation unit” which monitors the process of pursuing causes of the claims and collates data such as interpretation order and graphs used.

In this imaginary unit, a user can write from an arbitrary point of view via the terminal device 5 (FIG. 1B) and can store the arbitrary data in the unit. In addition, when a new imaginary unit is written, the user calls the already written imaginary unit on to a screen of the display 7 and designates and combines the data stored in the imaginary unit, thereby enabling the writing of a new imaginary unit. The written imaginary unit is preserved in the unit preservation portion 55 of the terminal device 5.

When a user designates an imaginary unit via the designation receiving section 51, the unit is obtained from the unit preservation portion 55, and the data thereof is displayed on the screen of the display 7 by the display section 54.

When the imaginary unit is called, arbitrary data included in the unit is used as a search key, and the unit may be searched by the searching section 52. For example, product names, lots, shipments, statuses of products or the like included in properties of a product unit (FIG. 2) are used as searching keys and the product units are searched, so that a necessary product unit can be extracted. Furthermore, when a process unit (FIG. 3) is called, data included in a property, a parameter and status of a process unit are used as search keys, so that a necessary process unit can be extracted.

As described above, since an arbitrary element other than a time stamp in the time series data can be used as a search key, access to necessary information can be made to be greatly efficient.

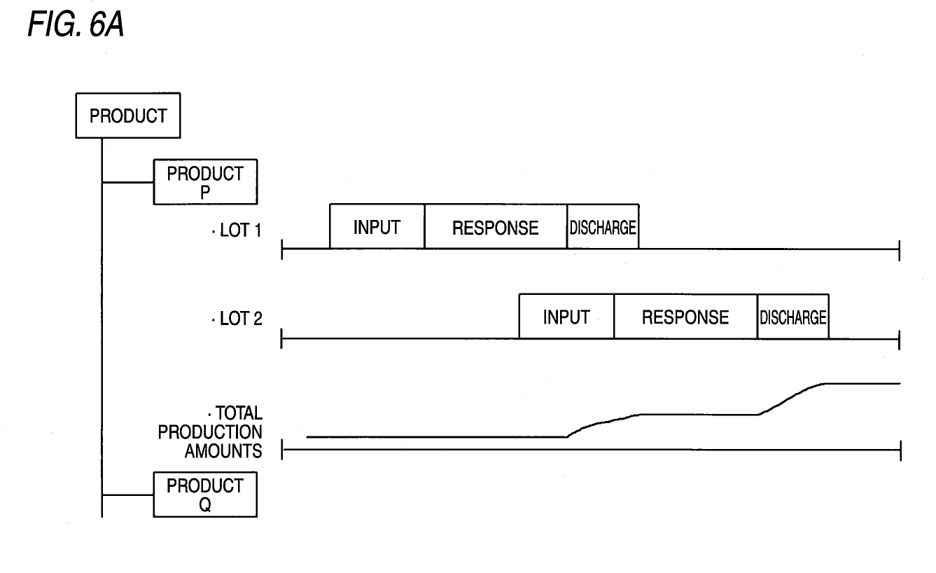

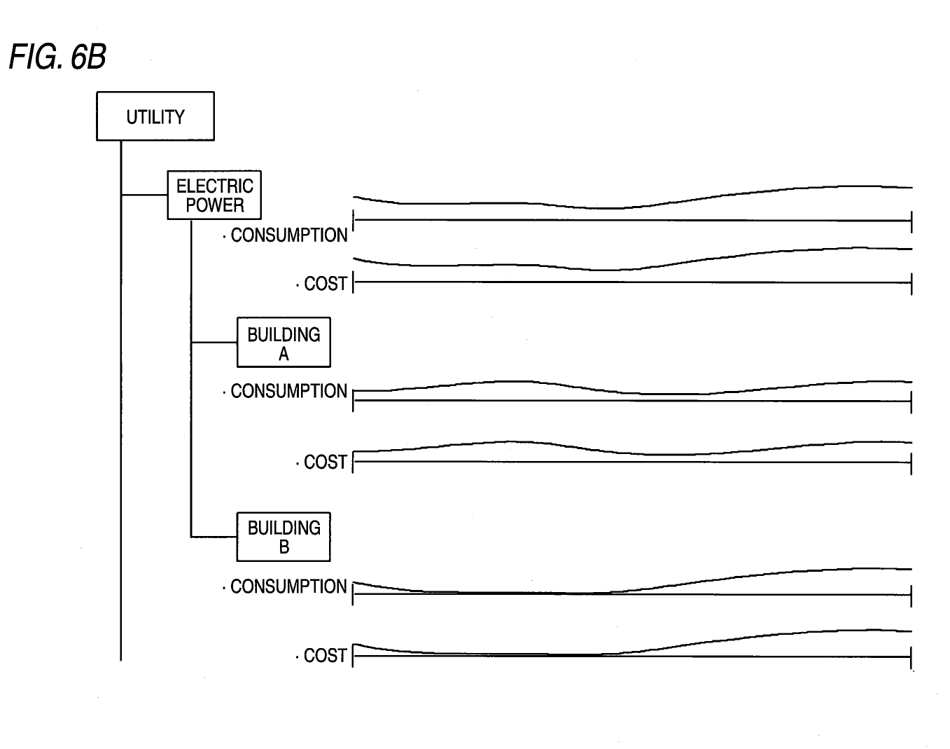

FIGS. 6 to 8 are diagrams that show an example of a corresponding relationship between each time series data (a part thereof) stored in an imaginary unit and the display configurations of each data. The data, which has been designated via the designation receiving section 51 or has been stored in the unit searched by the searching section 52, is graphically displayed on the screen of the display 7 by the display section 54.

For example, FIG. 6A shows a unit that stores a time series data group relating to products, and for each product (a product P and a product Q or the like), processes at every manufacturing lot and the entire production amount of products are included in the unit. The plurality of the time series data can be arranged and graphically displayed on the screen of the display 7, and in this case, the time series axis can be arranged in a line in accordance with the time stamp of each time series data.

Furthermore, FIG. 6B shows a unit that stores a time series data group relating to a utility, and energy kinds, energy consumption amounts at every building, and costs or the like are included in the unit. Similarly, in this case, the plurality of the time series data can also be graphically displayed on the screen of the display 7 in such a manner that the time axis is adjusted along the time stamp.

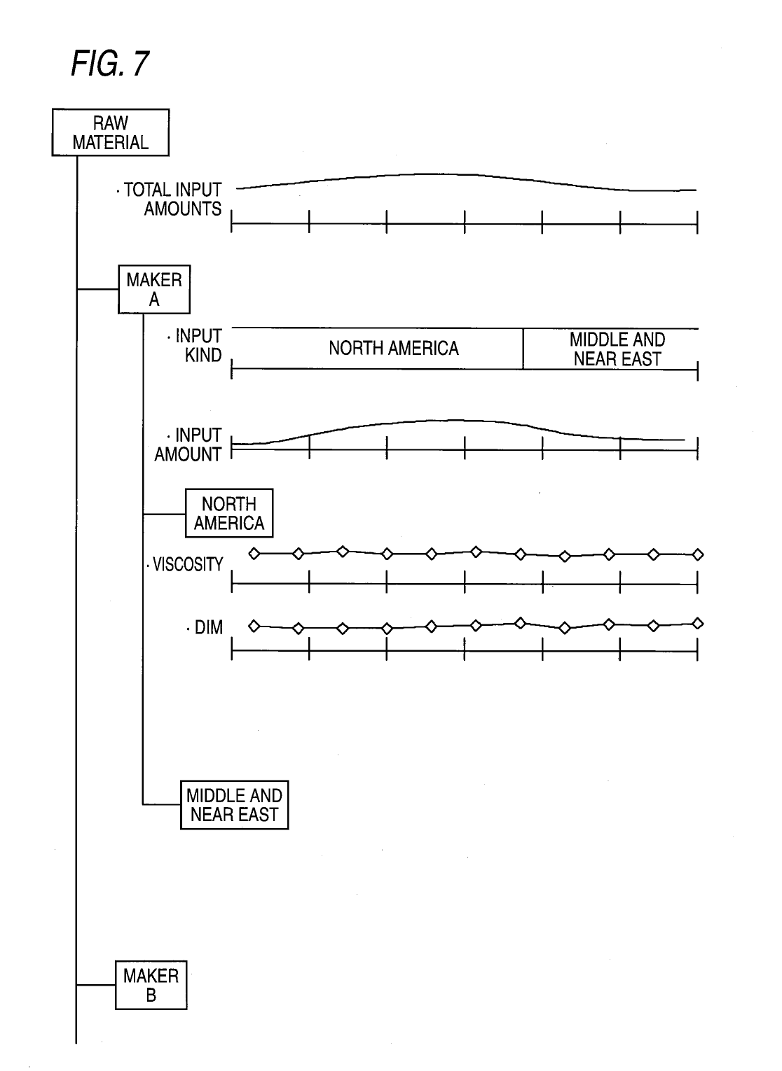

FIG. 7 shows a unit that stores a time series data group relating to a raw material to be input, and for each raw material maker and kind of raw material, an input amount and an inspection result of quality and the like are included in the unit. Similarly, in this case, the plurality of the time series data can also be graphically displayed on the screen of the display 7 in such a manner that the time axis is adjusted along the time stamp.

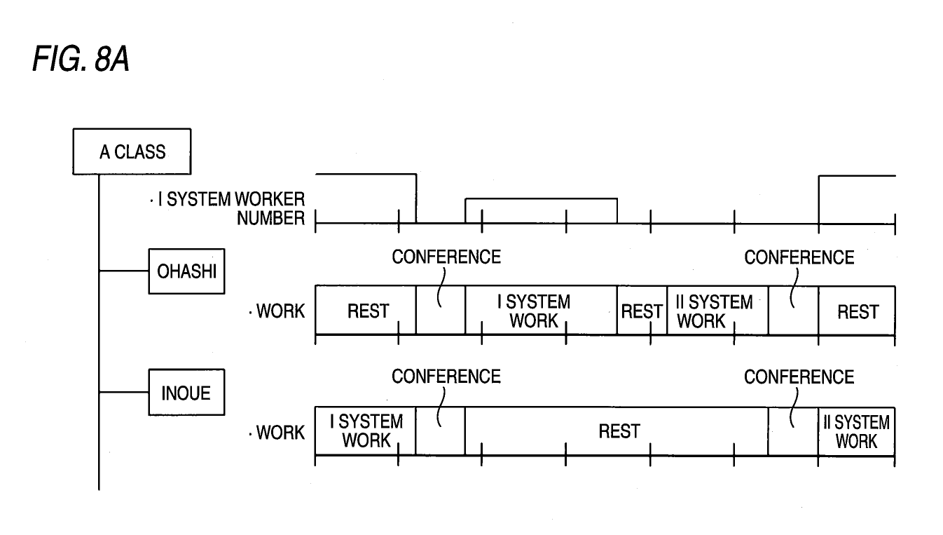

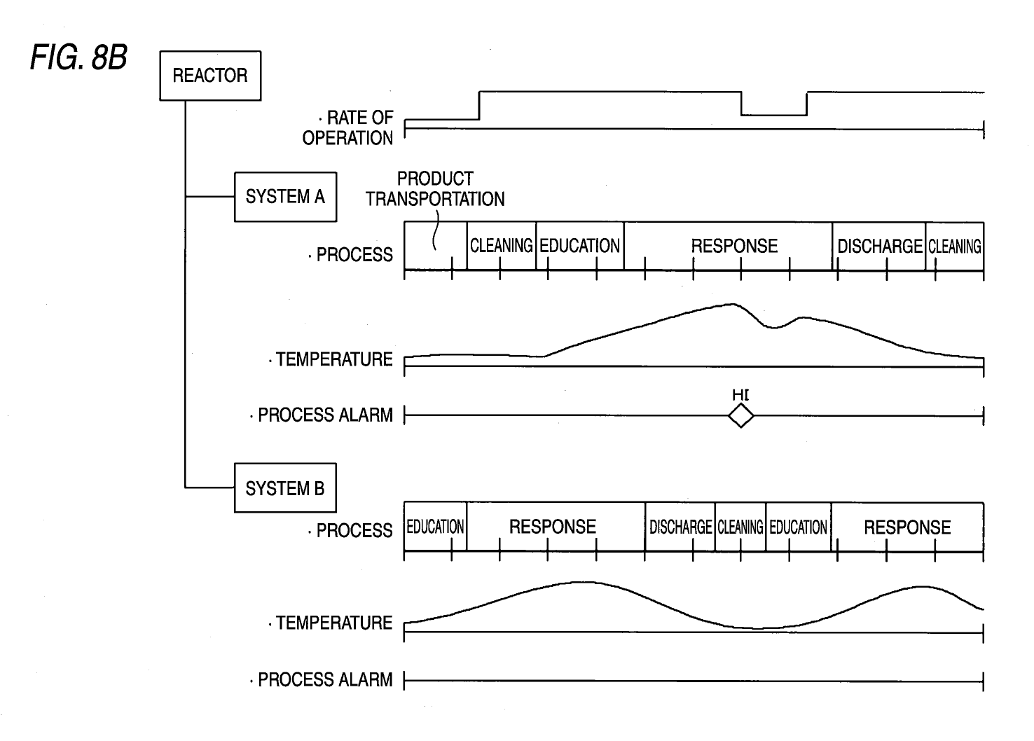

FIG. 8A shows a unit that stores a time series data group relating to a person, and a personal schedule and the total number of persons relating to each work or the like are included in the unit. Similarly, in this case, the plurality of the time series data can also be graphically displayed on the screen of the display 7 in such a manner that the time axis is adjusted along the time stamp.

FIG. 8B shows a unit that stores a time series data group relating to a device (reactor), and for each system of the reactor, a process and a process data or the like are included in the unit. Similarly, in this case, the plurality of the time series data can also be graphically displayed on the screen of the display 7 in such a manner that the time axis is adjusted along the time stamp.

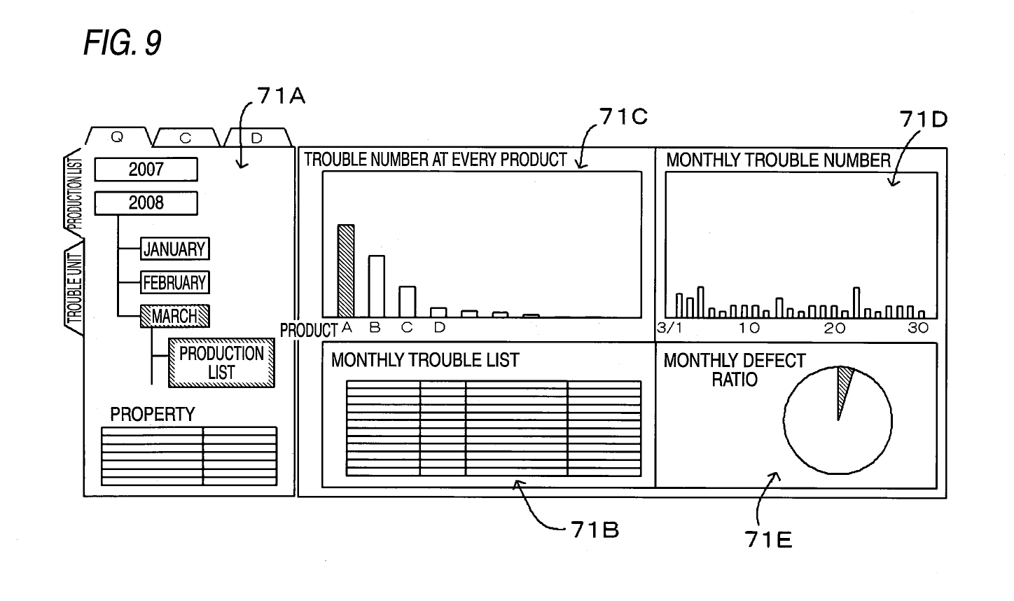

FIGS. 9 to 11 show diagrams of examples of display screens of the display 7.

FIG. 9 shows an interpretation screen when a trouble arises in a product. Herein, “a product list” is developed and displayed in an area 71A, so that a production date is designated. A production date included in a product unit (FIG. 2) is searched by using the designated production date as a search key, so that the number of trouble occurrences (the number of times a status of a product unit indicates a trouble) can be extracted.

In this way, the user can provide the imaginary unit with a stratification structure. In the area 71A, a screen display is performed based on a given stratification structure, and if a specific unit is selected (clicked), a unit group of one lower level is developed and displayed. The developed and displayed unit is selected (for example, double-clicked), so that it can be developed to the display screen of the data stored in the unit. The other units described later are identical thereto.

The extraction results are displayed as a monthly trouble list in an area 71B. Furthermore, in an area 71C, the number of the troubles for every product (a product A, a product B, . . . ) included in the monthly trouble list are graphically displayed. In an area 71D, by searching a production date of a lot with a trouble, the numbers of troubles (the number of lots) of each day for a month are graphically displayed. In addition, a result in which the numbers of troubles (the number of lots) for a month are divided by the number of all the lots is displayed as a monthly defective proportion in an area 71E.

The display configuration of this data can be set by an operation of a user who mediates the display screen of the display 7. Furthermore, this data group and the display configuration are registered as an imaginary unit named as “trouble 001”, for example, and can be preserved in the unit preservation portion 55 (FIG. 1B). The trouble unit preserved in the unit preservation portion 55 can be called on the screen of the display 7 according to an operation of a user who always mediates the terminal device 5, and the display configuration is reproduced.

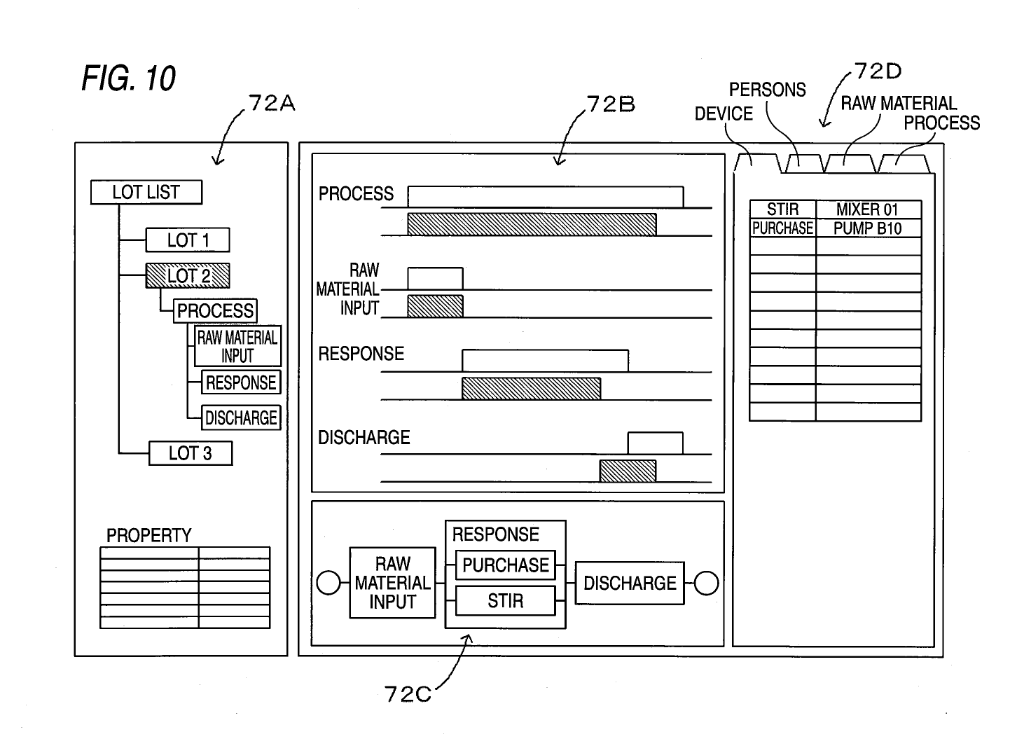

FIG. 10 shows an interpretation screen of a batch process. Herein, a “lot list” is developed and displayed in an area 72A, and a specific lot (“lot 2”) is designated. The process unit (FIG. 3) is searched by using the designated lot as a search key, so that the time series data of the process for the lot can be obtained.

This time series data is graphically displayed in an area 72B. In addition, the user designates an ideal batch (golden batch) among the data stored in the server 4 (FIG. 1A) as historical data and can obtain the time series data of this process. In the example of FIG. 10, the time series data of the process relating to the lot and the golden batch are all displayed in such a manner that the time axis is adjusted. In the example of FIG. 10, both time axes are adjusted on the basis of the start of the process, and at the same time, by arranging each in relation to the overall processes (“process”), a raw material introduction process (“raw introduction”), and a reaction process (“reaction”) and a taking out process (“out”), the required time of each process or the like can be compared.

In an area 72C, “a production process” is obtained from the “flow” of the searched process unit and is displayed.

A reference unit is displayed in an area 72D. A user can designate the reference unit via the terminal device 5. The reference unit is designated on the screen so that the unit can be called on the screen of the display 7 from the unit preservation portion 55.

The data group and the display configuration contained in the interpretation screen in FIG. 10 written by the user is, for example, registered as an imaginary unit named as “an interpretation 001 order” and can be preserved in the unit preservation portion 55. The interpretation unit preserved in the unit preservation portion 55 can be called on the screen of the display 7 according to the operation of the user who always mediates the terminal device 5, and the display configuration is reproduced. By calling this screen during the operation of the plant, it is possible to easily obtain a suitable operation order or the like. In addition, when the operation order and the cause of the trouble or the like are investigated afterward, it is possible to simply obtain the necessary information.

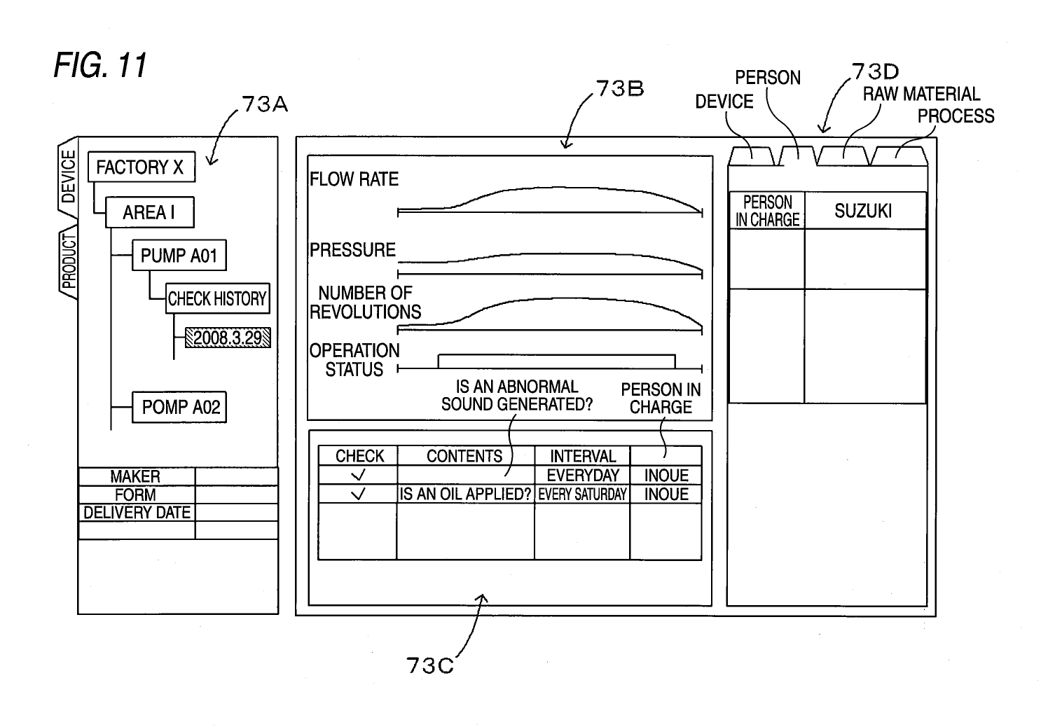

FIG. 11 shows a display screen indicating the detailed information of the device. Herein, a list of the device is developed and displayed in an area 73A to designate an inspection history of a specific device (“pump A01”). The device unit (FIG. 5) is searched by using the designated device as the search key, so that field data (FIG. 5) at the time of inspection for the device can be obtained.

The obtained field data (time series data) is graphically displayed in a state in which time axes are arranged each relative to other in an area 73B.

Furthermore, a “check sheet” is obtained from a “file” of the searched device unit and is displayed in an area 73C.

The reference unit is displayed in an area 73D. The reference unit can be designated by the user. When the reference unit is designated on the screen, the unit is called on the screen of the display 7 from the unit preservation portion 55.

The data group and the display configuration included in the screen of FIG. 11 written by the user can be preserved as an imaginary unit in the unit preservation portion 55. The unit preserved in the unit preservation portion 55 can be called on the screen of the display 7 according to the operation of the user who always mediates the terminal device 5, and the display configuration is reproduced.

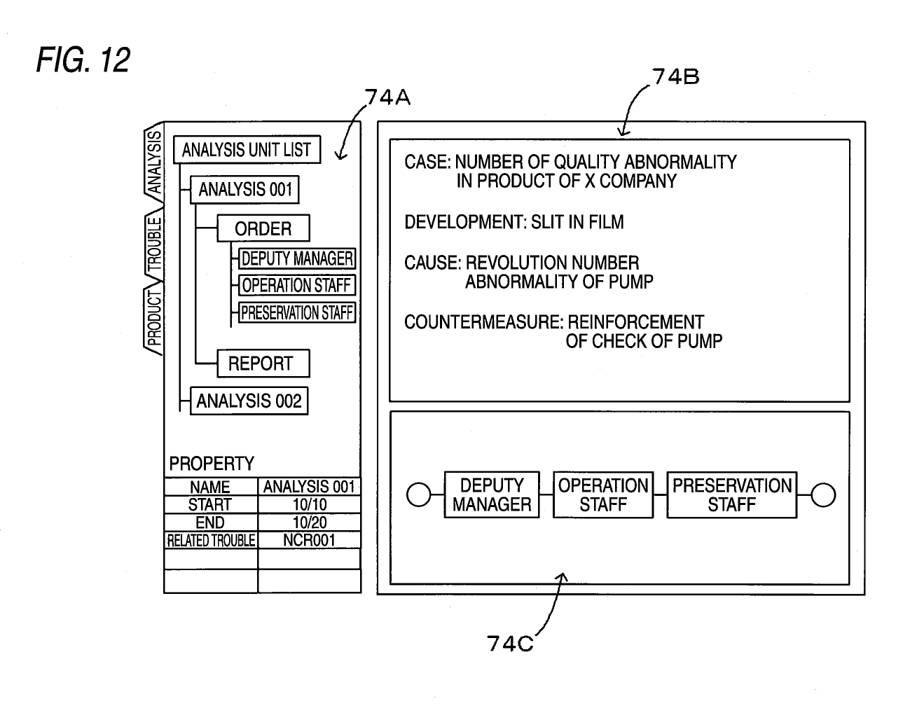

FIG. 12 shows a display screen of report information of a plant. In the example of FIG. 12, the list of the interpretation unit in an area 74A is developed and displayed and a “report” of a specific interpretation unit is selected, so that the report result (file image) of the interpretation is displayed in an area 74B. Furthermore, a flow of the interpretation is displayed in an area 74C.

The data group and the display configuration, which has been written by the user and included in the screen of FIG. 12, can be preserved, for example, as an imaginary unit called as “interpretation 001 report” in the unit preservation portion 55. The unit preserved in the unit preservation portion 55 can be called on the screen of the display 7 according to the operation of the user who always meditates the terminal device 5, and the display configuration is reproduced.

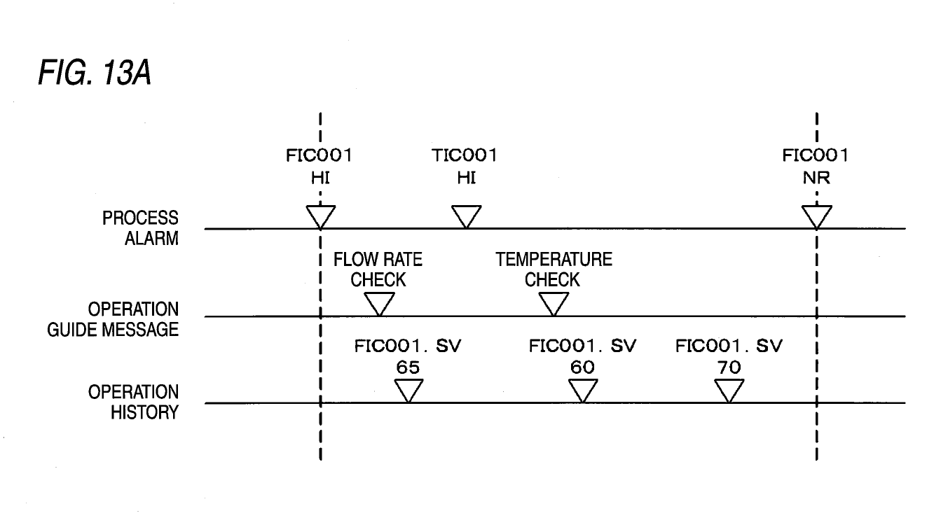

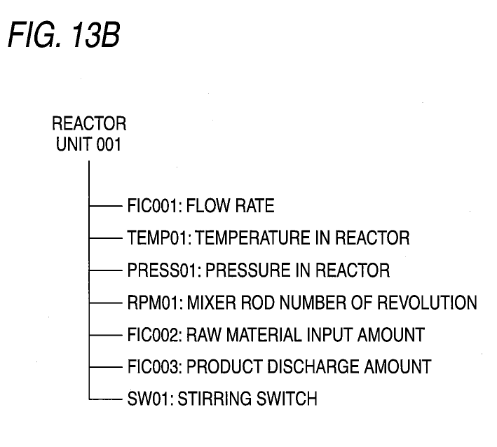

Hereinafter, with reference to FIGS. 13 to 15, there is described one method of using an imaginary unit for operative support at the time of occurrence of the alarm.

FIG. 13A shows one example of an event (time series data) constituting a past case of a response to an alarm. As shown in FIG. 13A, histories of events such as a history of a process alarm relating to the response to the alarm, a reporting history of an operation guide message, and an operation history are taken out from historical data stored in the server 4 and are suitably associated. The association of the events to be used in the past cases can be arbitrarily set by the user. The past cases are obtained by searching the process unit. For example, “a process soundness” (FIG. 3) in “status” is searched as the search key, so that the corresponding lot can be extracted and the histories of the events are obtainable.

Furthermore, FIG. 13B shows field data (time series data) included in the device unit (reactor unit). By combining the field data relating to the response to the alarm with the event, the past cases of the response to the alarm are written. The corresponding field data can be obtained by specifying “device” (FIG. 3) in the device (“parameter”) used in the lot constituting the past case.

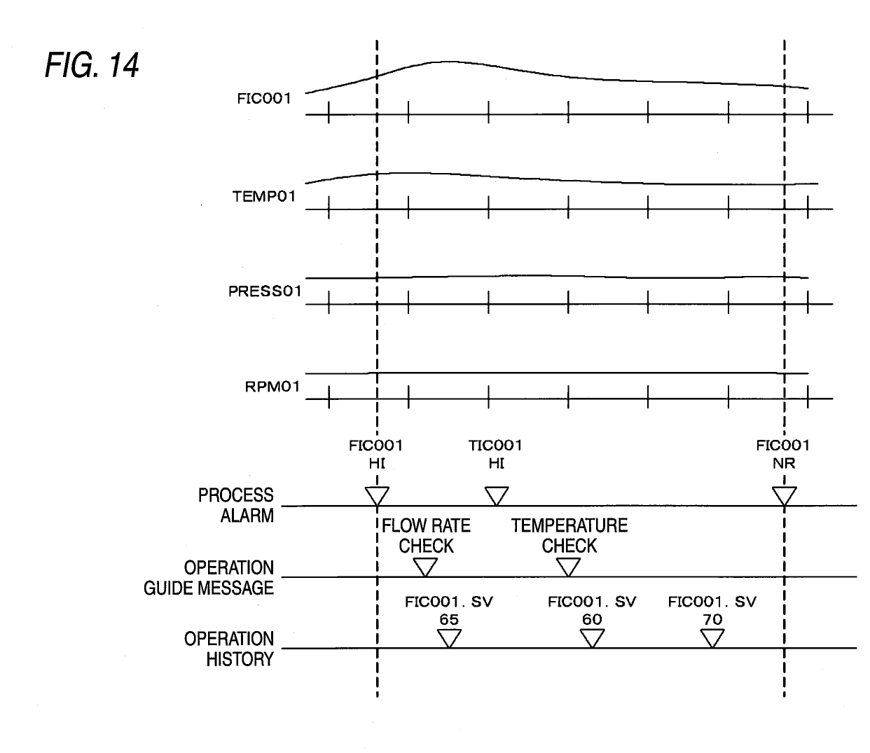

FIG. 14 shows a graphic display example of the written past cases. In the example of FIG. 14, based on each time stamp, the field data relating to the response to the alarm and the event are arranged and graphically displayed in a state in which the time axis is arrayed on the screen of the display 7.

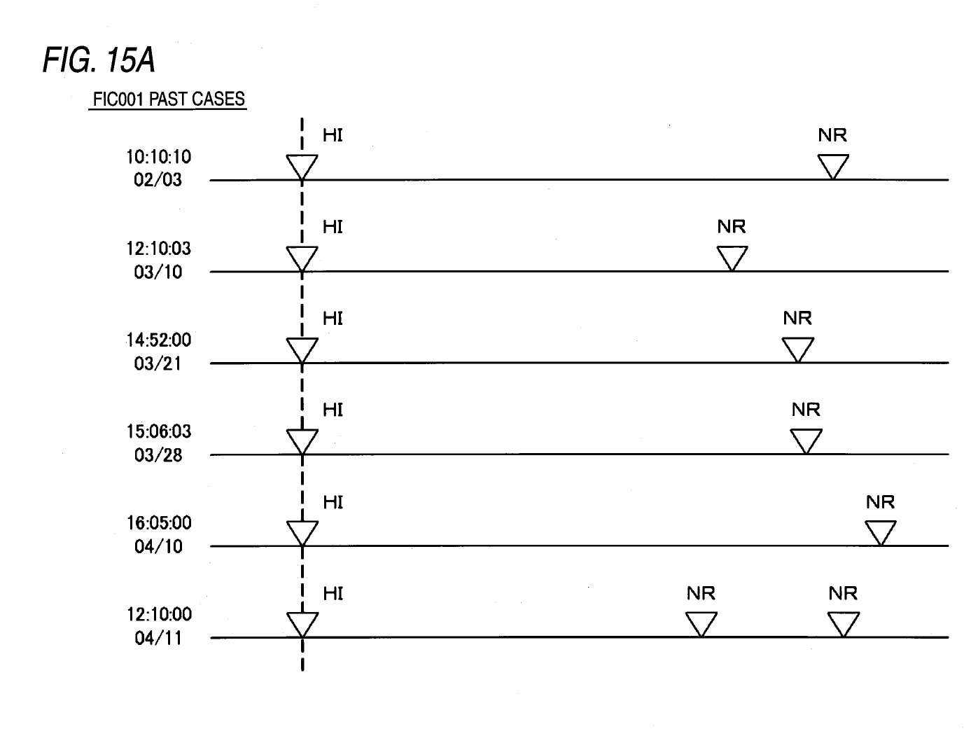

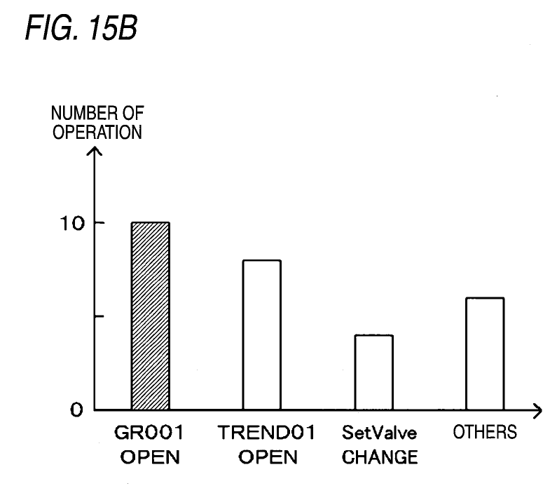

FIG. 15A shows an example in which timings of the events in a plurality of the past cases are graphically displayed. In this example, each display position is regulated so that the occurrence time points (“HI” in FIG. 15A) of the alarm in each of the past cases are united on the screen of the display 7, whereby there is obtained a display configuration in which times from the occurrence time point of the alarm to a recovery time point (“NR” in FIG. 15A) can be compared in an instant. The present plant situation in which the alarm occurs can be displayed so as to be arranged in parallel to the past cases in such a manner that the time axis is arrayed.

FIG. 15B shows an example of a display screen that displays the number distribution of operation contents to be adopted later after occurrence of the alarm. The operation number is counted by searching the past cases with the search section 52 and at the same time a statistical processing such as standardization is executed by the statistical processing section 53, so that the number of each operation and the order of the operation number of each operation are calculated. As shown in FIG. 15B, the calculation result in the statistical processing section 53 is reflected on the display screen of the display 7. In the example of FIG. 15B, there is displayed a graph in which operation contents are indicated on a transverse axis and the selected operation numbers of each of the operation contents are indicated on a longitudinal axis, and the numbers of each of the operation contents are displayed in order starting with the largest operation number. By referring to this display, working staff can grasp operation contents to be executed later.

The data and the display configuration constituting the screen (FIGS. 13 to 15) written by the user can be registered as an imaginary image and are preserved in the unit preservation portion 55.

When the alarm is raised, the working staff searches the imaginary unit of the unit preservation unit 55 with the searching section 52 under the search condition corresponding to the present alarm situation, so that the past cases corresponding to the present alarm situation can be called on the screen of the display 7, whereby it is possible to obtain a suitable response method to the alarm. In addition, when the working staff executes certain operation after occurrence of the alarm, the past cases are selected carefully by researching the past cases on the basis of the operation contents, so that the usefulness of the information displayed on the screen of the display 7 can be improved. For example, by repeating the research, a distribution (FIG. 15B) of the operation number for the next operation is displayed on the screen in real time. Thus, the working staff can grasp the operation contents to be newly executed.

As described above, by accumulating a method of response to the alarm and presenting the method at the time of necessity, it is possible to facilitate the quick decision-making of the working staff. In addition, by storing the necessary data group as a unit at the time of occurrence of the alarm, it is possible to quickly display only the necessary data among the vast data with a small procedure. Furthermore, a real operation executed at the time of occurrence of the alarm and the results thereof are accumulated as historical data in the server 4 so that they can be used as the past cases. For this reason, the user continuously uses the system so that a special engineering work is not required and a reliability of the information required for the decision-making can be improved.

Even in the same alarm, the best response method may differ depending on the temperature and the weather at that time, the raw material producer, the age of a device, the line used and the like. In order to be able to respond to this case, at the time of searching the past cases, the temperature and the weather, the operation condition and the raw material producer, and the maintenance timing of a device and the like may be carefully selected and used as the condition. In this case, by carefully selecting the data and the imaginary unit in which the information is made to correspond to the lot, the lot satisfying the condition can be extracted.

As a condition for carefully selecting the past cases, a data with a layer structure can be used. By adjusting the condition to the layer structure, a characteristic of a vague data can be clarified.

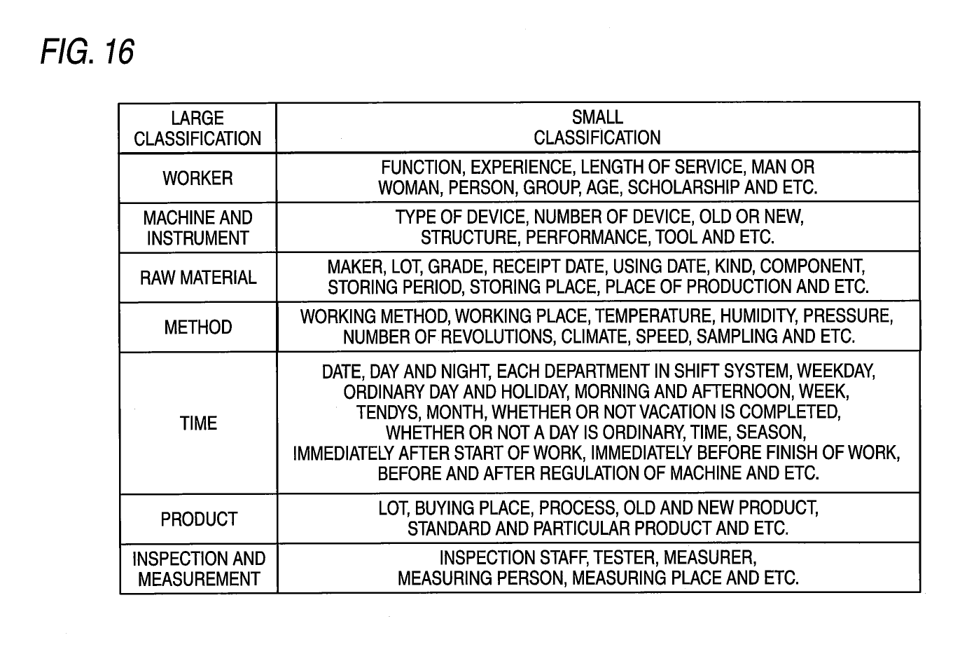

FIG. 16 shows an example in which the careful selection condition is divided into two-staged layers of a large clarification and a small clarification.

As described above, according to the plant information managing device of the present invention, by writing a collection of the data according to the purpose of an imaginary unit, a unification of the data from a point of view of a user is made possible. As a result, easy access to the necessary data group is made possible, and at the same time, by preserving the imaginary unit, the collection of the data can also be used elsewhere.

Furthermore, the imaginary unit and the data group are searched by using the data stored in the imaginary unit as the search key, so that the past data is searched by using a simultaneous search of a product and the same operation condition as the key, thereby resulting in easy access to the necessary data. For example, at the time of occurrence of the trouble or the like, it is also possible to rapidly refer to the past cases.

As described above, according to the plant information managing device and the plant information managing method of the present invention, the time series data which has received the designation is graphically displayed, so that the data group relating to the plant can be effectively used.

An application range of the invention is not limited to the above-described embodiments. The invention is widely applicable to plant information managing device and the plant information managing method which manage the data group relating to the plant.

What is claimed is:

1. A plant information managing device for managing a time series data group relating to a plant, comprising:
a designation receiving section for receiving a designation of the time series data, and
a display section for graphically displaying the time series data which has received the designation by the designation receiving section.

2. The plant information managing device as in claim 1, further comprising:
a searching section for searching the time series data according to a searching condition for designating the time series data which has been received by the designation receiving section, wherein
the display section graphically displays the time series data which has been extracted from the search by the searching section.

3. The plant information managing device as in claim 1, wherein
the display section displays the graphical displays of a plurality of the time series data in such a manner that time axes thereof are uniformly arranged in relation to each other.

4. The plant information managing device as in claim 1, further comprising:
a statistical processing section for performing a statistical processing based on the time series data which has been extracted from the search by the searching section, wherein
the display section displays the results which are based on the statistical processing according to the statistical processing.

5. The plant information managing device as in claim 1, wherein
the time series data relates to alarm information.

6. The plant information managing device as in claim 1, wherein
the time series data relates to an operation in a plant.

7. The plant information managing device as in claim 1, wherein
the time series data is historical data.

8. A plant information managing method of managing a time series data group relating to a plant, comprising:
receiving a designation of the time series data, and
graphically displaying the time series data which has been received in the step of receiving the designation.
